(19) United States
(12) Patent Application Publication
(10) Pub. No.: US 2025/0315491 A1
(43) Pub. Date: Oct. 9, 2025

(54) DATA TRANSFORMATION FOR WEB SEARCH USING PROPRIETARY DATA

(71) Applicant: Zagmo Corporation, San Francisco, CA (US)

(72) Inventor: Scott Banister, San Rafael, CA (US)

(21) Appl. No.: 18/628,215

(22) Filed: Apr. 5, 2024

(51) Int. Cl. G06F 16/9538; G06N 5/022

(52) U.S. Cl. CPC G06F 16/9538; G06N 5/022

(57) ABSTRACT

A user input data is received. The user input data is used as an input to a knowledge retrieval engine configured to generate in response to the input a generated response that is derived at least in part from a set of proprietary data. The generated response is used to generate a set of web search results.

A user input data is received. The user input data is used as a first input to a first knowledge retrieval engine configured to generate in response to the first input an intermediate response that is derived at least in part from a set of proprietary data. The intermediate response is used as a second input to a second knowledge retrieval engine configured to generate in response to the second input a generated response that is derived at least in part from the set of proprietary data.

### BACKGROUND OF THE INVENTION

Responding to a query is a useful task of modern computing devices. Queries posed in natural language grammar and/or keywords rather than logical and/or machine language are more accessible by human users but introduce more ambiguity. Efficient response to natural language queries provides an improvement by enhancing the user experience in posing the natural language query by reducing the time needed to clarify the query and/or the time needed for a useful response. Efficient response to natural language queries also provides an improvement by reducing computing resources required for such a response, such as processing resources, memory resources, storage resources, and/or network resources.

### BRIEF DESCRIPTION OF THE DRAWINGS

Various embodiments of the invention are disclosed in the following detailed description and the accompanying drawings.

FIG. 1 is a functional diagram illustrating a programmed computer/server system for facilitating query transformation for web search using proprietary data in accordance with some embodiments.

FIG. 2A is a user interface rendering illustrating an example of a generic query response.

FIG. 2B is a user interface rendering illustrating an example of a query response utilizing a knowledge retrieval engine.

FIG. 3A is a flow diagram illustrating an embodiment of a process for query transformation for web search using proprietary data.

FIG. 3B is a flow diagram illustrating an embodiment of a process for query transformation for web search using proprietary data with a fine-tuned LLM as a knowledge retrieval engine.

FIG. 3C is a flow diagram illustrating an embodiment of a process for query transformation for web search using proprietary data with a search index and LLM as a knowledge retrieval engine.

FIG. 3D is a flow diagram illustrating an embodiment of a process for query transformation for web search using proprietary data with a search index and LLM as a knowledge retrieval engine to generate a summary.

FIG. 3E is a flow diagram illustrating an embodiment of a process for query transformation for web search using proprietary data and a combination including a knowledge retrieval engine.

FIG. 4A is a flow diagram illustrating an embodiment of a process for query transformation using proprietary data with a plurality of knowledge retrieval engines.

FIG. 4B is a flow diagram illustrating an embodiment of a process for query transformation using proprietary data with a serially arranged set of knowledge retrieval engines and a summary.

FIG. 4C is a flow diagram illustrating an embodiment of a process for query transformation using proprietary data with a serially arranged set of knowledge retrieval engines and a hypothetical answer.

FIG. 4D is a flow diagram illustrating an embodiment of a process for query transformation for web search using proprietary data with a plurality of knowledge retrieval engines.

FIG. 5A is a flow diagram illustrating an embodiment of a process for query transformation for web search using proprietary data such as customer-owned data.

FIG. 5B is a flow diagram illustrating an embodiment of a process for query transformation for generated response using proprietary data such as customer-owned data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Query transformation for web search using proprietary data is disclosed. As referred to herein, proprietary data comprises any data that is unique to and typically owned by an organization or individual. Proprietary data may include private data, such as pointers, lists, definitions, etc. that defines or otherwise identifies a set of data from non-proprietary sources.

One example of proprietary data is customer-owned data such as a customer's internal files or knowledge bases. A service provider may have a plurality of customers, and each customer may have customer-owned data. The service provider may provide a service that uses a customer's customer-owned data. Typically, care is taken to use a given customer's data only for the benefit of that customer.

Techniques are disclosed to use proprietary data to provide more context, for example by contextualizing a query. As the proprietary data conceptually transforms a query, an improvement is that the query takes on more meaning coming indirectly from the proprietary data. This reduces the time and space required for a query as contextual details may be added or enhanced using the proprietary data and may produce results more aligned with the interests and needs of the user with whom the query is associated.

A user provides a query, as referred to herein, as comprising a natural language/chat prompt and/or a search query. The proprietary data is prepared in part to create a knowledge retrieval engine, as referred to herein, as a system that provides a response to a query. In one embodiment, a knowledge retrieval engine is a query system that takes and leverages proprietary data so that it becomes most useful for input to a web search engine.

For example, (1) in one embodiment, the proprietary data is used to fine-tune a large language model (LLM), such that the fine-tuned LLM is the knowledge retrieval engine. For example, (2) in one embodiment, the proprietary data is used to create a searchable index, wherein the searchable index may without limitation use embeddings and/or a vector database to enhance its performance. The searchable index may return extractions to be input to an LLM, which may be generic or fine-tuned using the proprietary data. The searchable index and extraction-input LLM is another example of a knowledge retrieval engine.

As referred to herein, an extraction is any searchable index result. In one embodiment, an extraction may include one or more sentences and/or passages from a document indexed by the searchable index, which may be centered around the query term. For example, an extraction may be four sentences from a white paper, with two sentences immediately preceding a query keyword and two sentences immediately succeeding the query keyword. In one embodiment, information indexed by the searchable index may include at least one of the following: word processor documents, spreadsheets and/or worksheets, natural language documents, tabular data, slide presentations, multimedia documents, hyperlinked documents, and/or images; and appropriate converters are used to provide a natural language representation for the searchable index.

Responses are generated using the knowledge retrieval engine. For example, (1) in one embodiment, a query is input to a fine-tuned LLM to produce a hypothetical answer. For example, (2) in one embodiment, a query is input to a searchable index and extraction-input LLM, which uses those extractions and the query to produce a hypothetical answer. For example, (3) in one embodiment, a query is input to a searchable index and extraction-input LLM, which uses those extractions and the query to produce a summary.

Web search results are generated using the responses from one or more knowledge retrieval engines. For example, (1) in one embodiment a hypothetical answer from a fine-tuned LLM is used to generate web search results. For example, (2) in one embodiment a hypothetical answer from a searchable index and extraction-input LLM is used to generate web search results. For example, (3) in one embodiment a summary from a searchable index and extraction-input LLM is used to generate web search results. Combinations from these three examples and/or additional inputs may also be used to generate web search results.

Serially arranging two knowledge retrieval engines is disclosed. In one embodiment, a fine-tuned LLM is used as input to a searchable index and extraction-input LLM. In contrast to using a raw user query as input to a searchable index and extraction-input LLM, the raw user query is instead fed as input to a fine-tuned LLM and its hypothetical answer is used as input to a searchable index and extraction-input LLM to provide a summary and/or hypothetical answer.

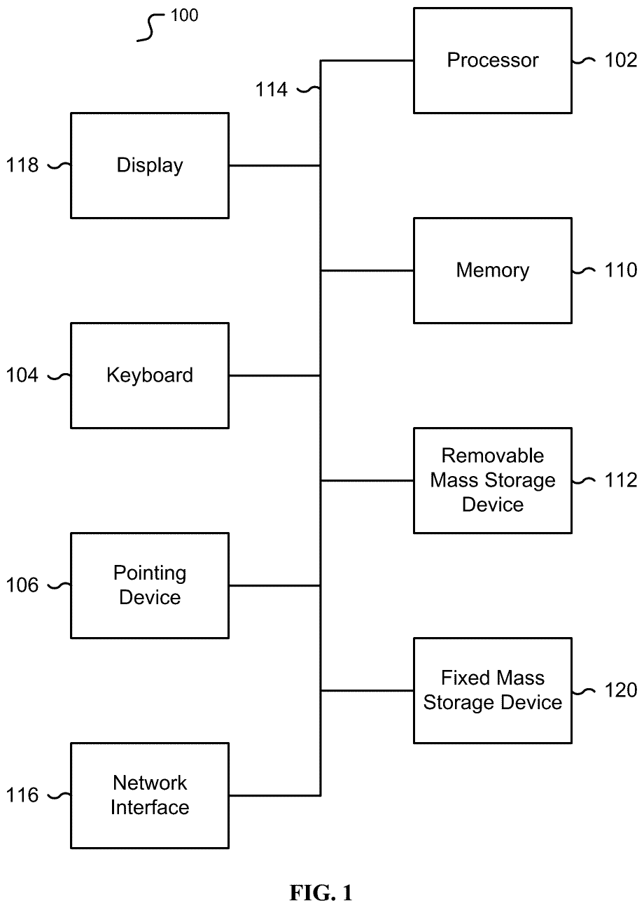

FIG. 1 is a functional diagram illustrating a programmed computer/server system for facilitating query transformation for web search using proprietary data in accordance with some embodiments. As shown, FIG. 1 provides a functional diagram of a general-purpose computer system programmed to facilitate query transformation for web search using proprietary data in accordance with some embodiments. As will be apparent, other computer system architectures and configurations can be used for facilitating query transformation for web search using proprietary data.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC” s), programmable logic devices (“PLD” s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

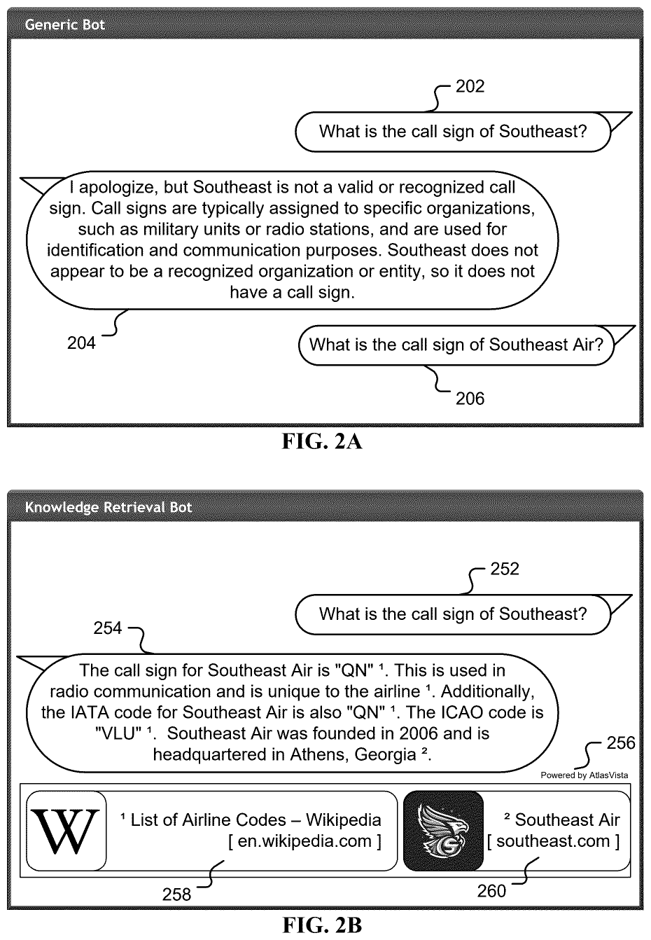

FIG. 2A is a user interface rendering illustrating an example of a generic query response. In one embodiment, the user interface rendering shown in FIG. 2A is rendered by the system of FIG. 1.

The UI (user interface) rendering of FIG. 2A is that of a “generic bot” or chatbot which as referred to herein is a UI that accepts queries in the form of a natural language “chat” interface that mimics human-to-human chat interfaces such as those for text messaging or SMS (short messaging service) messaging on a mobile phone. On the right side, a user queries “What is the call sign of Southeast?” (202) to reference an imaginary illustrative airline called Southeast Air. In the example of FIG. 2A, the generic bot uses a generic LLM to respond (204) that it does not recognize the natural language term “Southeast”, perhaps interpreting it to be an ordinal direction on a compass or a geographic/cultural region of a country. The user then unfortunately may have to repeat the query with more context and ask “What is the call sign of Southeast Air?” (206) or perhaps “What is the call sign of Southeast Air, an airlines company?”, which consumes a user's time and resource space with the repeated query, and increases in computing resources such as processing, memory, storage, and/or networking resources for query response.

FIG. 2B is a user interface rendering illustrating an example of a query response utilizing a knowledge retrieval engine. In one embodiment, the user interface rendering shown in FIG. 2B is rendered by the system of FIG. 1. The user interface rendering shown in FIG. 2B is meant to contrast that of FIG. 2A with a natural language chat interface using proprietary data to configure the knowledge retrieval engine, represented by a “knowledge retrieval bot” chatbot. For the illustrative purposes of the example in FIG. 2B, the proprietary data of FIG. 2B is that of an airlines management consulting organization, so that the knowledge retrieval engine is configured with the context of airline companies.

Similar to that in FIG. 2A, a user queries “What is the call sign of Southeast?” (252). Unlike in FIG. 2A, natural language term “Southeast” is better recognized using the proprietary data for airline companies. With the knowledge retrieval engine, improvements include less user time and resource space required, and decreases in computing resources such as processing, memory, storage, and/or networking resources for query response.

The query response (254) gives a hypothetical answer, referred to herein as an answer that provides an answer format and/or structure with contextual content associated with the proprietary data, in an analogy to how hypothetical document embeddings may be used with generic LLMs. The query response (254) may also and/or instead give a natural language summary. In the example of FIG. 2B, the hypothetical answer is that the call sign for Southeast Air is QN, the IATA code for Southeast Air is QN, and the ICAO code is VLU. In the example of FIG. 2B, the summary includes a description of a call sign as “used in radio communication and is unique to the airline”, that Southeast was founded in 2006, and the location of its headquarters. In one embodiment, the query response includes web search results.

In the example of FIG. 2B, an imaginary illustrative web search engine called Atlas Vista is used (256) to provide web search results. In one embodiment, web search results are cross-referenced in the hypothetical answer and/or summary, for example and without limitation as shown in response (254) by footnotes. For example, a first footnote references a first web search result as a Wikipedia article (258), and a second footnote references a second web search result as a corporate website for Southeast Air (260).

That is, the knowledge retrieval engine is contextualized in the sense of the search engine which clarifies that “Southeast” is the Southeast Air company referred to, what industry they are in, and/or what their full name is. By contrast, a straight web search deals with added ambiguity, such as whether “Southeast” is a direction or a company, what is the company name, what industry are they in. The knowledge retrieval engine reduces the ambiguity of the query or prompt given, transforming that before the web search. An improvement is less ambiguity and/or more specific/better matches from the web search.

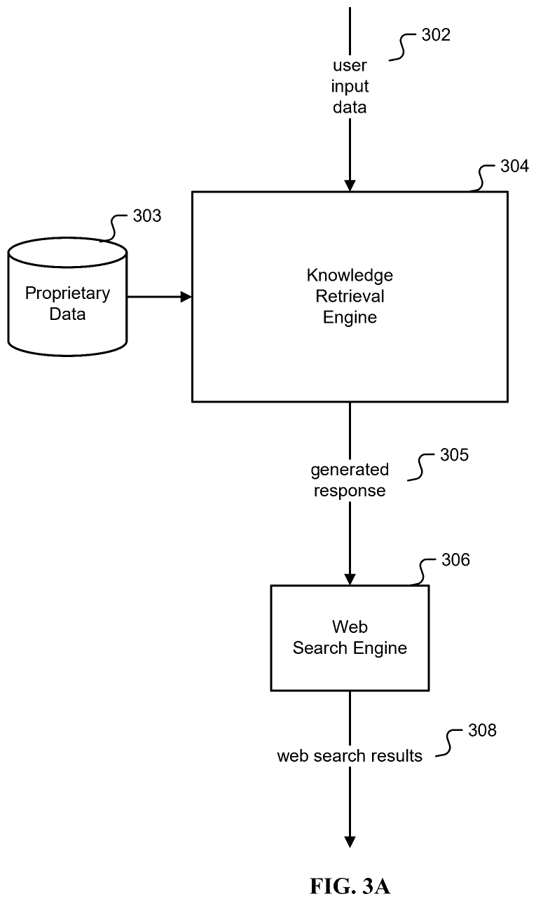

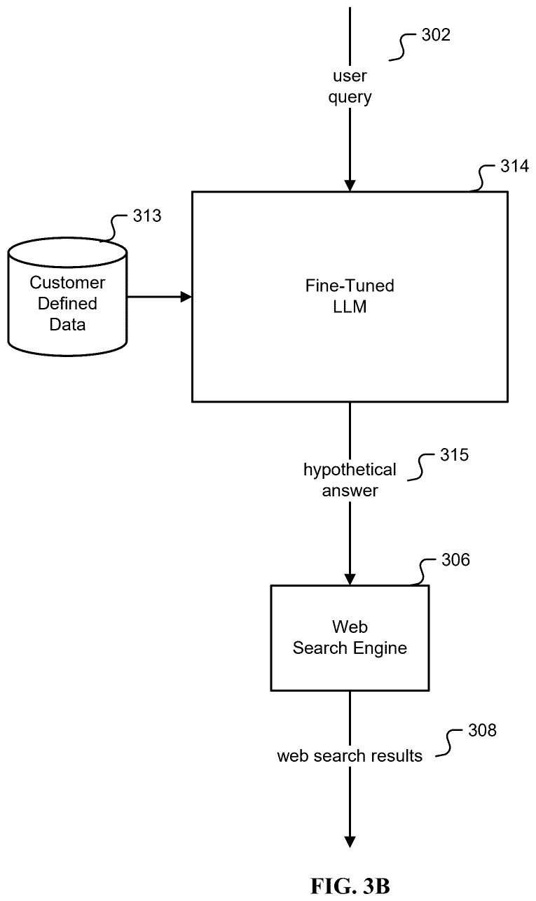

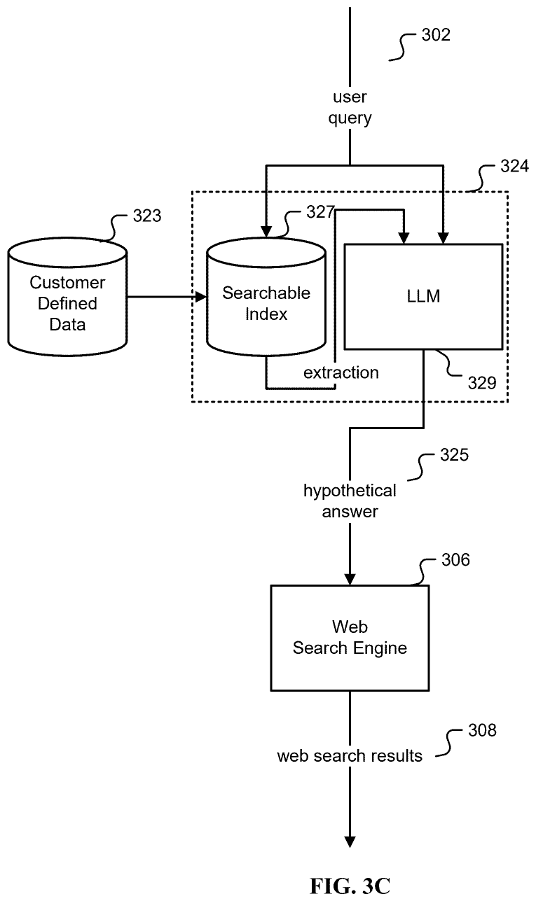

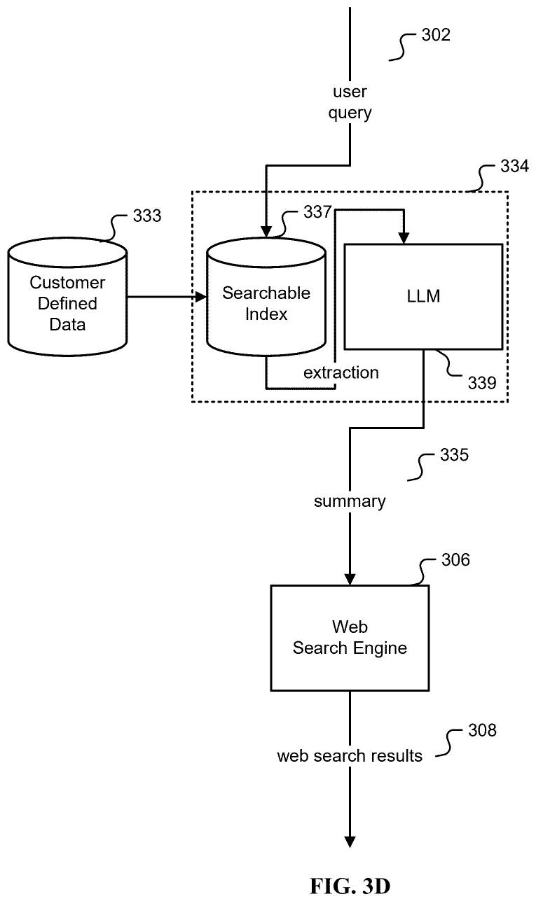

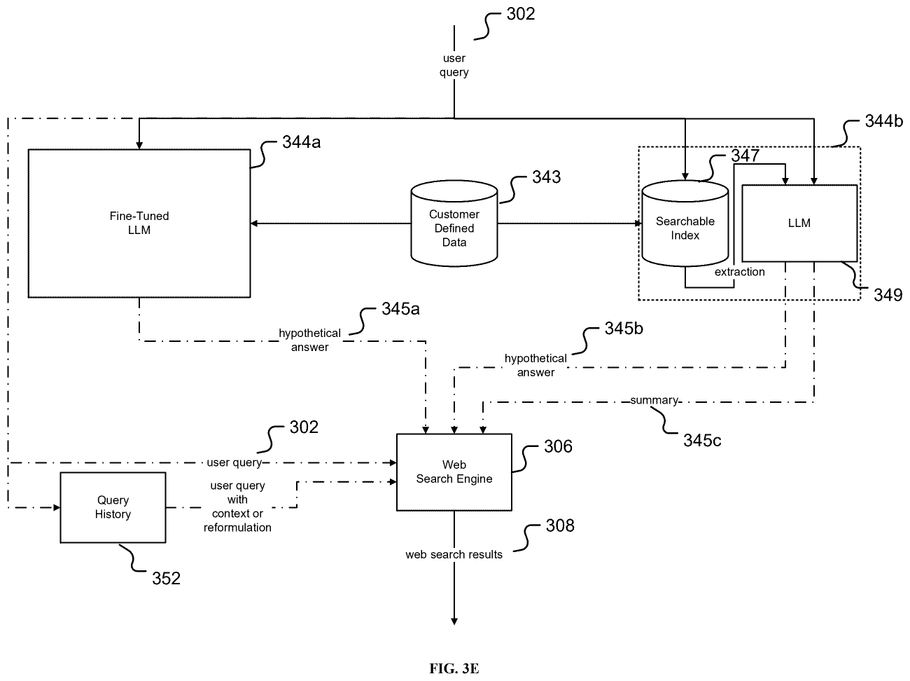

FIG. 3A is a flow diagram illustrating an embodiment of a process for query transformation for web search using proprietary data. In one embodiment, the flow diagram shown in FIG. 3A is carried out by the system of FIG. 1. In one embodiment, the flow diagram shown in FIG. 3A is rendered to a user, for example, in the user interface of FIG. 2B.

In one embodiment, a system for the flow diagram of FIG. 3A comprises a communication interface such as that shown as network interface (116) in FIG. 1, and a processor such as that shown as processor (102) in FIG. 1. The processor may be configured to receive a user input data (302) via the communication interface. The processor may be configured to use the user input data (302) as an input to a knowledge retrieval engine (304) configured to generate in response to the input (302) a generated response (305) that is derived at least in part from a set of proprietary data (303).

In some embodiments, the user input data (302) may be received from a user associated with one of a plurality of customers, e.g., a plurality of enterprise customers of a service provider with which the system of FIG. 3A is associated. In some such embodiments, the knowledge retrieval engine (304) may be configured to determine a specific customer with which the user input data (302) is associated and to use a set of proprietary data (303) that is associated with that customer. The same input data (e.g., query) coming from a different user associated with a different customer would result in a different set of proprietary data (303) associated the different customer being used.

Referring further to FIG. 3A, the processor may be configured to use the generated response (305) to generate a set of web search results (308), for example via a web search engine (306). As referred to herein, a web search engine is any system that provides hyperlinks to web and/or internet content in response to a user query. Examples of web search engines include search engines based on keyword matching, page and/or link ranking, and/or vectorization. In one embodiment, a web search engine ignores common words such as grammatical articles, and performs a deduplication of meaningful words, such that a concatenated query such as a longer transformed query provides improvement in search results. In one embodiment, a web search engine is used that promises privacy for clients, to reduce generated responses (305) from polluting a client's manual/future web search results.

In one embodiment, the interface to the web search engine (306) shown in FIG. 3A is via an API (application programming interface). In the event the web search engine API input limit is exceeded by the generated response (305), a query compression is used. In one embodiment, the query compression uses a truncation to limit the generated response (305) to the web search API input limit. In one embodiment, the query compression uses an intelligent truncation that uses, for example, an LLM with a prompt “rewrite the <generated response> to fit within <the web search API input limit>” or “rewrite the <generated response> to fit within a 5,000 character limit.”

The flow diagram of FIG. 3A is illustrative of a general knowledge retrieval engine (304). FIGS. 3B, 3C, 3D, and 3E are specific illustrations of embodiments of a knowledge retrieval engine (304).

FIG. 3B is a flow diagram illustrating an embodiment of a process for query transformation for web search using proprietary data with a fine-tuned LLM as a knowledge retrieval engine. In one embodiment, the flow diagram shown in FIG. 3B is carried out by the system of FIG. 1. In one embodiment, the flow diagram shown in FIG. 3B is rendered to a user, for example, in the user interface of FIG. 2B. In one embodiment, the flow diagram shown in FIG. 3B is an embodiment of the general system shown in FIG. 3A.

In one embodiment, a system for the flow diagram of FIG. 3B comprises a communication interface such as that shown as network interface (116) in FIG. 1, and a processor such as that shown as processor (102) in FIG. 1. The processor may be configured to receive a user input data (302) via the communication interface. The processor may be configured to use the user input data (302) as an input to a fine-tuned LLM (314) configured to generate in response to the input (302) a hypothetical answer (315) that is derived at least in part from a set of customer defined data (313). In one embodiment, the customer defined data (313) is customer owned such as proprietary knowledge for an airlines management consulting organization. In one embodiment, the customer defined data (313) is customer curated such as that for a zoological department at a university that includes a set of concepts and terminology for a specific field of zoology. The processor may be configured to use the hypothetical answer (315) to generate a set of web search results (308), for example via a web search engine (306).

The fine-tuned LLM (314) may without limitation be any pre-trained LLM that has been retrained on a dataset associated with the customer defined data (313). Examples of a fine-tuned LLM (314) include without limitation: an unsupervised fine-tuned LLM; a supervised fine-tuned LLM; a human feedback fine-tuned LLM using for example an RLHF (Reinforcement Learning From Human Feedback) technique; and/or a parameter reduced fine-tuned LLM using for example a PEFT (Parameter-Efficient Fine-Tuning) technique and/or LoRA (Low-Rank Adaptation) technique. In one embodiment, the fine-tuned LLM is a model that stores proprietary information (313) in a secure way. In one embodiment, the fine-tuned LLM is a model that stores proprietary information (313) to address a privacy concern and/or confidentiality concern.

For example, if the user query (302) is “What is the ticker symbol for Southeast?”, the customer defined data (313), which for example may be that for an airlines management consulting organization with older data, may fine-tune the LLM (314) so that a generated hypothetical answer (315) is “Southeast Air doesn't have a ticker symbol or trade on any stock exchange, as it is not yet a publicly traded company. Southeast has stated it plans in the future to go public on the NYSE.” In this example, this data (313) is outdated so that when this hypothetical answer (315) is input to a search engine (306), the web search results (308) include hyperlinks to financial websites that chart the publicly traded stock for Southeast Air which includes the current ticker symbol for Southeast Air, NYSE: HAT.

This example illustrates a principle that a hypothetical answer (315) need not have accurate or precise answer to improve the final web search results (308) by adding structural context and/or contextual hints to generate a more accurate or precise answer from the search engine (306), in comparison to the original user query (302), even in the event that the hypothetical answer (315) includes hallucinations from the fine-tuned LLM (314).

FIG. 3C is a flow diagram illustrating an embodiment of a process for query transformation for web search using proprietary data with a search index and LLM as a knowledge retrieval engine. In one embodiment, the flow diagram shown in FIG. 3C is carried out by the system of FIG. 1. In one embodiment, the flow diagram shown in FIG. 3C is rendered to a user, for example, in the user interface of FIG. 2B. In one embodiment, the flow diagram shown in FIG. 3C is an embodiment of the general system shown in FIG. 3A.

In one embodiment, a system for the flow diagram of FIG. 3C comprises a communication interface such as that shown as network interface (116) in FIG. 1, and a processor such as that shown as processor (102) in FIG. 1. The processor may be configured to receive a user input data like a user query (302) via the communication interface. The processor may be configured to use the user query (302) as an input to a knowledge retrieval engine (324) that comprises a searchable index (327) of customer defined data (323) which generates extractions for an LLM (329) configured to generate a hypothetical answer (325) in response to the user query (302) concatenated with extractions from the searchable index (327). In one embodiment, the LLM (329) is a generic LLM without fine-tuning. In one embodiment, the LLM (329) is a fine-tuned LLM similar to the LLM (314) depicted in FIG. 3B, for example retrained on a dataset associated with the customer defined data (323).

In one embodiment, the customer defined data (323) is customer owned such as proprietary knowledge for an airlines management consulting organization. In one embodiment, the customer defined data (323) is customer curated such as that for a zoological department at a university that includes a set of concepts and terminology for a specific field of zoology. The processor may be configured to use the hypothetical answer (325) to generate a set of web search results (308), for example via a web search engine (306).

The searchable index (327) may be of any index design for full-text indexing of natural language documents and multimedia (323). Examples of a searchable index (327) include without limitation: a suffix tree structure; an inverted index structure; an n-gram index structure; a keyword matching index; a page/document ranking to provide a relevance metric; and/or a vector database that accepts as input vectors of embeddings. For example, customer defined data (323) may be taken to do an embedding on it, the embeddings are put in a vector database, and when a query is input, the processor embeds the query and sends it to the vector database to find similar sections that are similar on a vector level. Thus given a vector of the query embedding and vectors in the database, the vectors which are a good match are output.

For example, if the user query (302) is “What is the ticker symbol for Southeast?”, the customer defined data (323), which for example may be that for an airlines management consulting organization with older data, may provide extractions from an old white paper that includes a paragraph extraction describing plans for Southeast to list on the NYSE. Extractions including this paragraph extraction and the user query (302) are input to the LLM (329), which in turn generates a hypothetical answer (325) “Southeast Air is not a publicly traded company. Southeast has stated it plans in the future to go public on the NYSE.” In this example, this data (323) is outdated so that when this hypothetical answer (325) is input to a search engine (306), the web search results (308) include hyperlinks to financial websites that chart the publicly traded stock for Southeast Air which includes the current ticker symbol for Southeast Air, NYSE: HAT.

This example illustrates the principle that a hypothetical answer (325) need not have accurate or precise answer to improve the final web search results (308) by adding structural context and/or contextual hints to generate a more accurate or precise answer from the search engine (306), in comparison to the original user query (302), even in the event that the hypothetical answer (325) includes hallucinations from the LLM (329).

This example illustrates another principle that an LLM (329) focuses data, in an analogy to a magnifying glass. That is, extractions alone from searchable index (327) may overwhelm a search engine (306), but passing the extractions through the LLM (329) may provide a more concise packet of information to the search engine (306) via the hypothetical answer (325)

FIG. 3D is a flow diagram illustrating an embodiment of a process for query transformation for web search using proprietary data with a search index and LLM as a knowledge retrieval engine to generate a summary. In one embodiment, the flow diagram shown in FIG. 3D is carried out by the system of FIG. 1. In one embodiment, the flow diagram shown in FIG. 3D is rendered to a user, for example, in the user interface of FIG. 2B. In one embodiment, the flow diagram shown in FIG. 3D is an embodiment of the general system shown in FIG. 3A.

In one embodiment, a system for the flow diagram of FIG. 3D comprises a communication interface such as that shown as network interface (116) in FIG. 1, and a processor such as that shown as processor (102) in FIG. 1. The processor may be configured to receive a user input data like a user query (302) via the communication interface. The processor may be configured to use the user query (302) as an input to a knowledge retrieval engine (334) that comprises a searchable index (337) of customer defined data (333) which generates extractions for an LLM (339) configured to generate a summary (335) in response to extractions from the searchable index (337). For example, a natural language prompt to request a summary from the LLM (339) may be “Please do not answer my query, please just provide a summary of all these document extracts.” In one embodiment, the LLM (339) is a generic LLM without fine-tuning. In one embodiment, the LLM (339) is a fine-tuned LLM similar to the LLM (314) depicted in FIG. 3B.

In one embodiment, the customer defined data (333) is customer owned such as proprietary knowledge for an airlines management consulting organization. In one embodiment, the customer defined data (333) is customer curated such as that for a zoological department at a university that includes a set of concepts and terminology for a specific field of zoology. The processor may be configured to use the summary (335) to generate a set of web search results (308), for example via a web search engine (306).

The searchable index (337) may be of any index design for full-text indexing of natural language documents and multimedia (333). Examples of a searchable index (337) include without limitation: a suffix tree structure; an inverted index structure; an n-gram index structure; a keyword matching index; a page/document ranking to provide a relevance metric; and/or a vector database that accepts as input vectors of embeddings.

For example, if the user query (302) is “What is the ticker symbol for Southeast?”, the customer defined data (333), which for example may be that for an airlines management consulting organization with older data, may provide extractions from an old white paper that includes a paragraph extraction describing plans for Southeast to list on the NYSE. Extractions including this paragraph extraction and the user query (302) are input to the LLM (339), which in turn generates a summary (335) “Southeast Air is an airline company founded in 2006 and headquartered in Athens, Georgia. Southeast is not a publicly traded company but has stated it plans in the future to go public on the NYSE.” In this example, this data (333) is outdated so that when this summary (335) is input to a search engine (306), the web search results (308) include hyperlinks to financial websites that chart the publicly traded stock for Southeast Air which includes the current ticker symbol for Southeast Air, NYSE: HAT.

FIG. 3E is a flow diagram illustrating an embodiment of a process for query transformation for web search using proprietary data and a combination including a knowledge retrieval engine. In one embodiment, the flow diagram shown in FIG. 3E is carried out by the system of FIG. 1. In one embodiment, the flow diagram shown in FIG. 3E is rendered to a user, for example, in the user interface of FIG. 2B. In one embodiment, the flow diagram shown in FIG. 3E is an embodiment that includes at least one of the general system shown in FIG. 3A.

In one embodiment, a system for the flow diagram of FIG. 3E comprises a communication interface such as that shown as network interface (116) in FIG. 1, and a processor such as that shown as processor (102) in FIG. 1. The processor may be configured to receive a user input data like a user query (302) via the communication interface, to provide input to a web search engine (306) in order to receive web search results (308) from the web search engine (306).

In one embodiment, a combination of flows are used to provide input to the web search engine (306). This combination may comprise one or more of the following, with the dash-dotted lines in FIG. 3E indicating zero or more of each of the associated elements:
The user query (302);
A user query with context and/or reformulation, based at least in part on a user query history (352) that in part comprises memory of past user queries. For example, if a first query is “What is the ticker symbol for Southeast?” and a subsequent query is “Where do they fly?”, a query/question reformulator may look at a chat log and/or query log and understand that the “they” refers to Southeast, and reformat the query to stand alone as “Where does Southeast fly?”;
A hypothetical answer (345a) from a fine-tuned LLM (344a) retrained on a dataset associated with the customer defined data (343), as described further in FIG. 3B;
A hypothetical answer (345b) from a knowledge retrieval engine (344b) that comprises a searchable index (347) based at least in part on the customer defined data (343) which generates extractions for an LLM (349) configured to generate the hypothetical answer (345b) in response to the user query (302) concatenated with extractions from the searchable index (347), as described further in FIG. 3C;
A summary (345c) from a knowledge retrieval engine, as described further in FIG. 3D. In FIG. 3E this is shown without limitation for simplicity to be the same knowledge retrieval engine (344b) as the one that generates the hypothetical answer (345b), but may be a separate knowledge retrieval engine based at least in part on customer defined data (333); and/or
Any additional inputs, for example web browsing history or query history. For example, portions of the web browsing history may be relevant to the current user query and portions of the web browsing history are used to further improve and/or enhance the current web search results.

In one embodiment, the particular combination of elements as shown in FIG. 3E is statically determined for a given knowledge domain and/or customer defined data. In one embodiment, the particular combination of elements as shown in FIG. 3E is dynamically determined based at least in part on past results, machine learning, and/or customer feedback.

As an example for FIG. 3E, and continuing earlier examples, if the user query (302) is “What is the ticker symbol for Southeast?”, the customer defined data (333), which for example may be that for an airlines management consulting organization with older data, may provide extractions from an old white paper that includes a paragraph extraction describing plans for Southeast to list on the NYSE. The combination of input to web search engine (306) may include in this example:
the user query (302) “What is the ticker symbol for Southeast?”;
a past user query (352) “Are airlines a good investment?”;
a hypothetical answer (345a) “Southeast Air doesn't have a ticker symbol or trade on any stock exchange, as it is not yet a publicly traded company. Southeast has stated it plans in the future to go public on the NYSE”;
a hypothetical answer (345b) “Southeast Air is not a publicly traded company. Southeast has stated it plans in the future to go public on the NYSE”; and/or
a summary (345c) “Southeast Air is an airline company founded in 2006 and headquartered in Athens, Georgia. Southeast is not a publicly traded company but has stated it plans in the future to go public on the NYSE.”

With the combination of inputs, in this example the web search results (308) include hyperlinks to financial websites that chart the publicly traded stock for Southeast Air which includes the current ticker symbol for Southeast Air, NYSE: HAT.

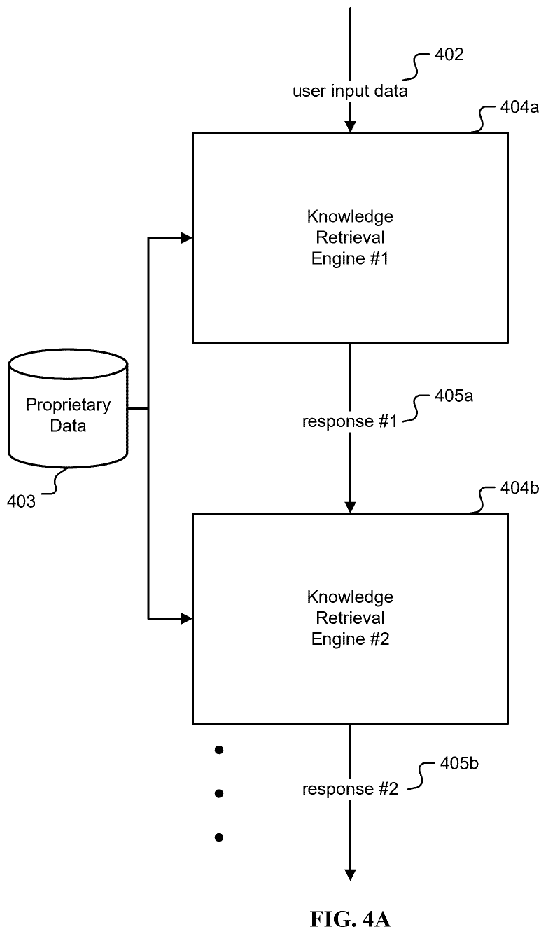

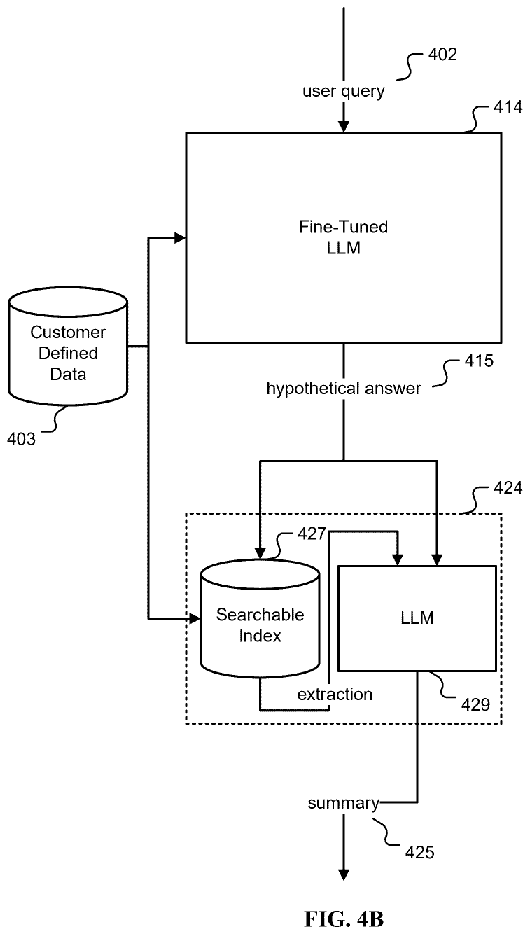

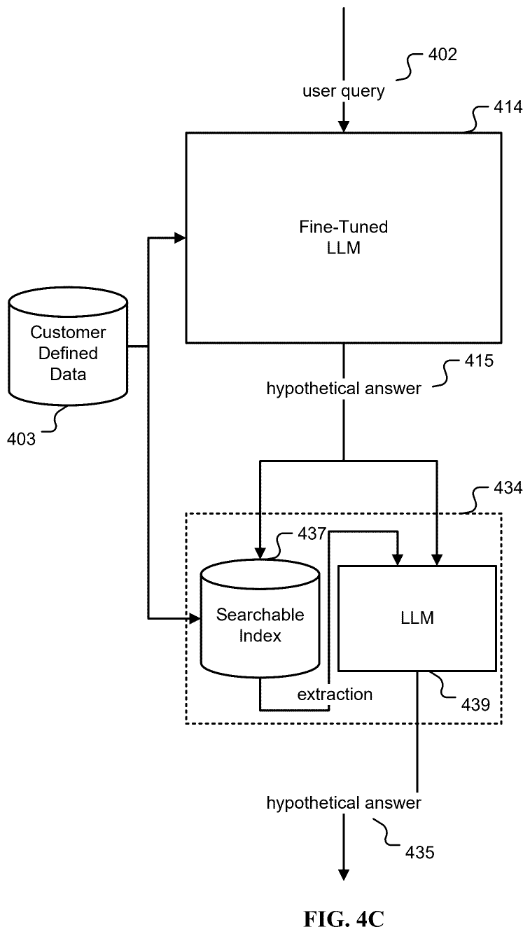

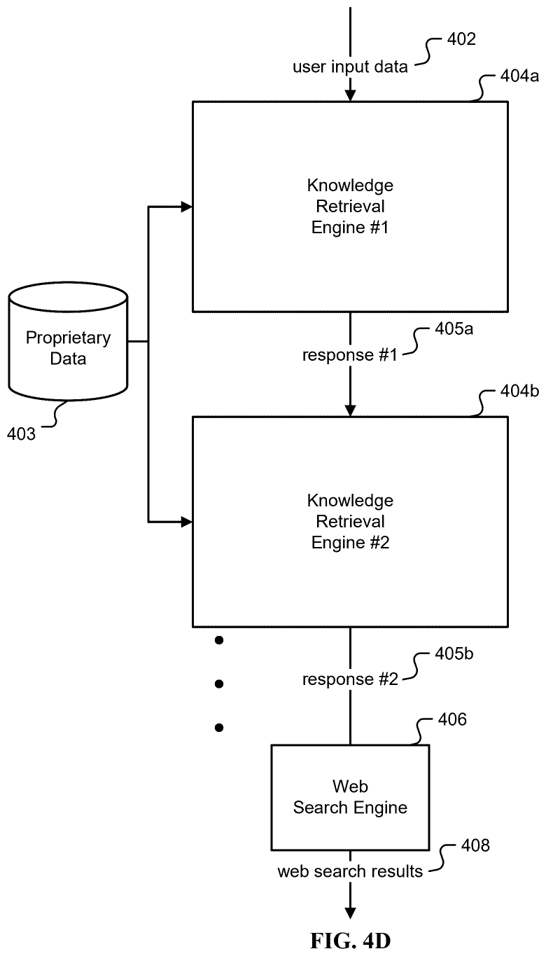

FIG. 4A is a flow diagram illustrating an embodiment of a process for query transformation using proprietary data with a plurality of knowledge retrieval engines. In one embodiment, the flow diagram shown in FIG. 4A is carried out by the system of FIG. 1. In one embodiment, the flow diagram shown in FIG. 4A is rendered to a user, for example, as a chat window as depicted to the user interface of FIG. 2B but without search engine results (256) necessarily.

In one embodiment, a system for the flow diagram of FIG. 4A comprises a communication interface such as that shown as network interface (116) in FIG. 1, and a processor such as that shown as processor (102) in FIG. 1. The processor may be configured to receive a user input data (402) via the communication interface. The processor may be configured to use the user input data (402) as an input to a first knowledge retrieval engine (404a) configured to generate a first response (405a) in response to the input (402) and derived at least in part from a set of proprietary data (403). The processor may be configured to use the input (402) and/or first response (405a) as an input to a second knowledge retrieval engine (404b) configured to generate a second response (405b) that is derived at least in part from the set of proprietary data (403). The example in FIG. 4A shows two serially arranged sets of knowledge retrieval engines, but without limitation, more than two serially arranged sets of knowledge retrieval engines may be used, for example five engines each with five responses. Other arrangements of knowledge retrieval engines may be used, for example knowledge retrieval engines may be arranged in parallel instead of in series, or arranged for recursion.

The flow diagram of FIG. 4A is illustrative of a general knowledge retrieval engine (404a), (404b). FIGS. 4B and 4C are specific illustrations of embodiments of a plurality of serially arranged knowledge retrieval engines.

FIG. 4B is a flow diagram illustrating an embodiment of a process for query transformation using proprietary data with a serially arranged set of knowledge retrieval engines and a summary. In one embodiment, the flow diagram shown in FIG. 4B is carried out by the system of FIG. 1. In one embodiment, the flow diagram shown in FIG. 4B is rendered to a user, for example, as a chat window as depicted to the user interface of FIG. 2B but without search engine results (256) necessarily.

In one embodiment, a system for the flow diagram of FIG. 4B comprises a communication interface such as that shown as network interface (116) in FIG. 1, and a processor such as that shown as processor (102) in FIG. 1. The processor may be configured to receive a user input data (402) via the communication interface. The processor may be configured to use the user input data (402) as an input to a fine-tuned LLM (414) configured to generate in response to the input (402) a hypothetical answer (415). The fine-tuned LLM (414) may be retrained on a dataset associated with the customer defined data (403). In one embodiment, the customer defined data (403) is customer owned such as proprietary knowledge for an airlines management consulting organization. In one embodiment, the customer defined data (403) is customer curated such as that for a zoological department at a university that includes a set of concepts and terminology for a specific field of zoology.

The processor is configured to use the hypothetical answer (415) as input to a serially arranged knowledge retrieval engine, for example a knowledge retrieval engine (424) that comprises a searchable index (427) of customer defined data (403) which generates extractions for an LLM (429) configured to generate in response to the hypothetical answer (415) and extractions from the searchable index (427) as output a summary (425) of the extractions. For example, a natural language prompt to request a summary from the LLM (429) may be “Please do not answer my query, please just provide a summary of all these document extracts.” In one embodiment, the LLM (429) is a generic LLM without fine-tuning. In one embodiment, the LLM (429) is a fine-tuned LLM similar to the LLM (414), for example retrained on a dataset associated with the customer defined data (403).

For example, a user query (402) is “What is the ticker symbol for Southeast?”, so that a hypothetical answer (415) may be “Southeast Air doesn't have a ticker symbol or trade on any stock exchange, as it is not yet a publicly traded company. Southeast has stated it plans in the future to go public on the NYSE”, and the subsequent summary (425) may be “Southeast Air is an airline company founded in 2006 and headquartered in Athens, Georgia. Southeast is not a publicly traded company but has stated it plans in the future to go public on the NYSE. A related ticker symbol is the current ticker symbol for Northeast Air, NYSE: LOV.”

FIG. 4C is a flow diagram illustrating an embodiment of a process for query transformation using proprietary data with a serially arranged set of knowledge retrieval engines and a hypothetical answer. In one embodiment, the flow diagram shown in FIG. 4C is carried out by the system of FIG. 1. In one embodiment, the flow diagram shown in FIG. 4C is rendered to a user, for example, as a chat window as depicted to the user interface of FIG. 2B but without search engine results (256) necessarily.

In one embodiment, a system for the flow diagram of FIG. 4C comprises a communication interface such as that shown as network interface (116) in FIG. 1, and a processor such as that shown as processor (102) in FIG. 1. The processor may be configured to receive a user input data (402) via the communication interface. The processor may be configured to use the user input data (402) as an input to a fine-tuned LLM (414) configured to generate in response to the input (402) a hypothetical answer (415). The fine-tuned LLM (414) may be retrained on a dataset associated with the customer defined data (403). In one embodiment, the customer defined data (403) is customer owned such as proprietary knowledge for an airlines management consulting organization. In one embodiment, the customer defined data (403) is customer curated such as that for a zoological department at a university that includes a set of concepts and terminology for a specific field of zoology.

The processor is configured to use the hypothetical answer (415) as input to a serially arranged knowledge retrieval engine, for example a knowledge retrieval engine (434) that comprises a searchable index (437) of customer defined data (403) which generates extractions for an LLM (439) configured to generate in response to the hypothetical answer (415) and extractions from the searchable index (437) as output a second hypothetical answer (435). In one embodiment, the LLM (439) is a generic LLM without fine-tuning. In one embodiment, the LLM (439) is a fine-tuned LLM similar to the LLM (414), for example retrained on a dataset associated with the customer defined data (403).

For example, a user query (402) is “What is the ticker symbol for Southeast?”, so that a hypothetical answer (415) may be “Southeast Air doesn't have a ticker symbol or trade on any stock exchange, as it is not yet a publicly traded company. Southeast has stated it plans in the future to go public on the NYSE”, and the subsequent second hypothetical answer (435) may be “Southeast Air is not a publicly traded company but has stated it plans in the future to go public on the NYSE. A related ticker symbol is the current ticker symbol for Northeast Air, NYSE: LOV.”

FIG. 4D is a flow diagram illustrating an embodiment of a process for query transformation for web search using proprietary data with a plurality of knowledge retrieval engines. In one embodiment, the flow diagram shown in FIG. 4D is carried out by the system of FIG. 1. In one embodiment, the flow diagram shown in FIG. 4D is rendered to a user, for example, in the user interface of FIG. 2B.

In one embodiment, a system for the flow diagram of FIG. 4D comprises a communication interface such as that shown as network interface (116) in FIG. 1, and a processor such as that shown as processor (102) in FIG. 1. The processor may be configured to receive a user input data (402) via the communication interface. The processor may be configured to use the user input data (402) as an input to a first knowledge retrieval engine (404a) configured to generate a first response (405a) in response to the input (402) derived at least in part from a set of proprietary data (403). The processor may be configured to use the first response (405a) and/or user input data (402) as input to a second knowledge retrieval engine (404b) configured to generate a second response (405b) derived at least in part from the set of proprietary data (403). Without limitation, additional knowledge retrieval engines may be arranged in series or otherwise, beyond the two shown for example in FIG. 4D. The processor may be configured to use the final response of all the plurality of knowledge retrieval engines, shown in FIG. 4D to be (405b), to generate a set of web search results (408), for example via a web search engine (406).

The example in FIG. 4D shows two serially arranged sets of knowledge retrieval engines, but without limitation, more than two serially arranged sets of knowledge retrieval engines may be used, for example five engines each with five responses. Other arrangements of knowledge retrieval engines may be used, for example knowledge retrieval engines may be arranged in parallel instead of in series, or arranged for recursion.

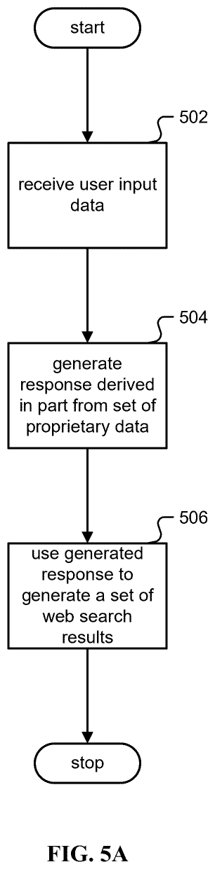

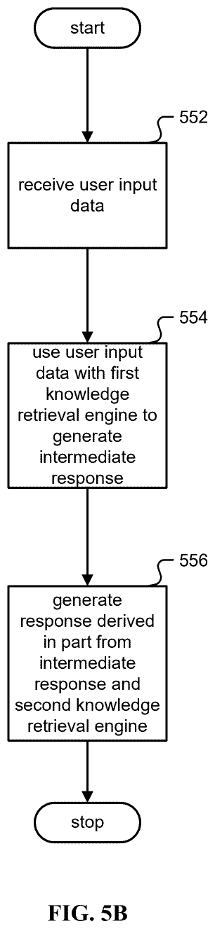

FIG. 5A is a flow diagram illustrating an embodiment of a process for query transformation for web search using proprietary data such as customer-owned data. In one embodiment, the flow diagram shown in FIG. 5A is carried out by the system of FIG. 1.

In step (502), a user input data is received. The user input data may be received via a communication interface such as (116) in FIG. 1. In step (504), the user input data is used as an input to a knowledge retrieval engine configured to generate in response to the input a generated response that is derived at least in part from a set of proprietary data. In step (506), the generated response is used to generate a set of web search results.

In one embodiment, the knowledge retrieval engine is a fine-tuned LLM. In one embodiment, the generated response is a hypothetical answer of the fine-tuned LLM. In one embodiment, the knowledge retrieval engine is a searchable index which returns extractions to an LLM. In one embodiment, the generated response is a hypothetical answer of the LLM to the user input data. In one embodiment, the generated response is a summary of returned extractions to the LLM.

In one embodiment, the generated response is concatenated with a second input. In one embodiment, the second input is a generated response of a second knowledge retrieval engine that uses the user input data as input. In one embodiment, the second input is the user input data. In one embodiment, the second input is a reformulated user input data that reflects context of a user input data history.

In one embodiment, the user input data comprises a natural language prompt or a search query for a chatbot. In one embodiment, the set of proprietary data is at least one of the following: a set of customer defined data and a set of customer owned data. In one embodiment, the generated set of web search results is presented to a user via a chatbot. In one embodiment, query compression is provided in the event the generated response is larger than a specified limit.

FIG. 5B is a flow diagram illustrating an embodiment of a process for query transformation for generated response using proprietary data such as customer-owned data. In one embodiment, the flow diagram shown in FIG. 5B is carried out by the system of FIG. 1.

In step (552), a user input data is received. The user input data may be received via a communication interface such as (116) in FIG. 1. In step (554), the user input data is used as a first input to a first knowledge retrieval engine configured to generate in response to the first input an intermediate response that is derived at least in part from a set of proprietary data. In step (556), the intermediate response is used as a second input to a second knowledge retrieval engine configured to generate in response to the second input a generated response that is derived at least in part from the set of proprietary data.

In one embodiment, the first knowledge retrieval engine is a fine-tuned LLM and the second knowledge retrieval engine is a searchable index which returns extractions to an LLM.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a communication interface; and
a processor coupled to the communication interface and configured to:
receive a user input data via the communication interface;
use the user input data as an input to a knowledge retrieval engine configured to generate in response to the input a generated response that is derived at least in part from a set of proprietary data;
wherein the knowledge retrieval engine is a system that provides a response to a query by leveraging proprietary data to improve an input to a web search engine;
wherein the query comprises a natural language chat prompt or a search query;
wherein proprietary data comprises any data unique to an organization or individual, comprising at least one of the following: word processor documents, spreadsheets, slide presentations, natural language documents, tabular data, or knowledge bases; and
use the generated response to generate a set of web search results.

2. The system of claim 1, wherein the knowledge retrieval engine is a fine-tuned large language model (LLM).

3. The system of claim 2, wherein the generated response is a hypothetical answer of the fine-tuned LLM.

4. The system of claim 1, wherein the knowledge retrieval engine is a searchable index which returns extractions to an LLM.

5. The system of claim 4, wherein the generated response is a hypothetical answer of the LLM to the user input data.

6. The system of claim 4, wherein the generated response is a summary of returned extractions to the LLM.

7. The system of claim 1, wherein the proprietary data comprises customer-owned data.

8. The system of claim 7, wherein the customer-owned data is associated with a first customer included in a plurality of customers associated with the system, and the customer-owned data is used as the proprietary data only for a subset of the plurality of customers that includes the first customer.

9. The system of claim 1, wherein the processor is further configured to concatenate the generated response with a second input.

10. The system of claim 9, wherein the second input is a second generated response of a second knowledge retrieval engine that uses the user input data as input.

11. The system of claim 9, wherein the second input is the user input data.

12. The system of claim 9, wherein the second input is a reformulated user input data that reflects context of a user input data history.

13. The system of claim 1, wherein the user input data comprises a natural language prompt or a search query for a chatbot or a search query.

14. The system of claim 1, wherein the set of proprietary data is at least one of: a set of customer defined data and a set of customer owned data.

15. The system of claim 1, wherein the set of web search results is presented to a user via a chatbot or via a search engine results page or via a link to a search engine results page.

16. The system of claim 1, wherein the processor is further configured to provide query compression in an event the generated response is larger than a specified limit.

17. A system, comprising:
a communication interface; and
a processor coupled to the communication interface and configured to:
receive a user input data via the communication interface;
use the user input data as a first input to a first knowledge retrieval engine configured to generate in response to the first input an intermediate response that is derived at least in part from a set of proprietary data;
wherein the knowledge retrieval engine is a system that provides a response to a query by leveraging proprietary data to improve an input to a web search engine;
wherein the query comprises a natural language chat prompt or a search query;
wherein proprietary data comprises any data unique to an organization or individual, comprising at least one of the following: word processor documents, spreadsheets, slide presentations, natural language documents, tabular data, or knowledge bases; and
use the intermediate response as a second input to a second knowledge retrieval engine configured to generate in response to the second input a generated response that is derived at least in part from the set of proprietary data.

18. The system of claim 17, wherein the first knowledge retrieval engine is a fine-tuned LLM and the second knowledge retrieval engine is a searchable index which returns extractions to an LLM.

19. The system of claim 17, wherein the processor is further configured to us the generated response to generate a set of web search results.

20. A method, comprising:
receiving a user input data;
using the user input data as an input to a knowledge retrieval engine configured to generate in response to the input a generated response that is derived at least in part from a set of proprietary data;
wherein the knowledge retrieval engine is a system that provides a response to a query by leveraging proprietary data to improve an input to a web search engine;
wherein the query comprises a natural language chat prompt or a search query;
wherein proprietary data comprises any data unique to an organization or individual, comprising at least one of the following: word processor documents, spreadsheets, slide presentations, natural language documents, tabular data, or knowledge bases; and
using the generated response to generate a set of web search results.

21. A method, comprising:
receiving a user input data;
using the user input data as a first input to a first knowledge retrieval engine configured to generate in response to the first input an intermediate response that is derived at least in part from a set of proprietary data;
wherein the first knowledge retrieval engine is a system that provides a response to a query by leveraging proprietary data to improve an input to a web search engine;
wherein the query comprises a natural language chat prompt or a search query;
wherein proprietary data comprises any data unique to an organization or individual, comprising at least one of the following: word processor documents, spreadsheets, slide presentations, natural language documents, tabular data, or knowledge bases; and
using the intermediate response as a second input to a second knowledge retrieval engine configured to generate in response to the second input a generated response that is derived at least in part from the set of proprietary data.

22. A computer program product embodied in a non-transitory computer readable medium and comprising computer instructions for:
receiving a user input data;
using the user input data as an input to a knowledge retrieval engine configured to generate in response to the input a generated response that is derived at least in part from a set of proprietary data;
wherein the knowledge retrieval engine is a system that provides a response to a query by leveraging proprietary data to improve an input to a web search engine;
wherein the query comprises a natural language chat prompt or a search query;
wherein proprietary data comprises any data unique to an organization or individual, comprising at least one of the following: word processor documents, spreadsheets, slide presentations, natural language documents, tabular data, or knowledge bases; and
using the generated response to generate a set of web search results.

23. A computer program product embodied in a non-transitory computer readable medium and comprising computer instructions for:
receiving a user input data;
using the user input data as a first input to a first knowledge retrieval engine configured to generate in response to the first input an intermediate response that is derived at least in part from a set of proprietary data;
wherein the first knowledge retrieval engine is a system that provides a response to a query by leveraging proprietary data to improve an input to a web search engine;
wherein the query comprises a natural language chat prompt or a search query;
wherein proprietary data comprises any data unique to an organization or individual, comprising at least one of the following: word processor documents, spreadsheets, slide presentations, natural language documents, tabular data, or knowledge bases; and
using the intermediate response as a second input to a second knowledge retrieval engine configured to generate in response to the second input a generated response that is derived at least in part from the set of proprietary data.
